(19) United States
(12) Patent Application Publication
(10) Pub. No.: US 2009/0211845 A1
(43) Pub. Date: Aug. 27, 2009

(54) Lockable folding stairs

(76) Inventors: Patrick Hoffman, Arlington, TX (US); David King, Allen, TX (US); Tom Murphy, Arlington, TX (US)

Correspondence Address: William R. Trueba, Jr.;Espinosa Trueba PL, 3001 S.W. 3rd Avenue, Miami, FL, 33129, US

(21) Appl. No.: 12/378,633

(22) Filed: Feb. 18, 2009

Related U.S. Application Data
(60) Provisional application No. 61/066,205, filed on Feb. 19, 2008.

(51) Int. Cl. E06C 1/00

(52) U.S. Cl. 182/165

(57) ABSTRACT

A two-piece locking folding stair is provided with a spring-like locking mechanism. The spring-like device, deployed one on of the two members, includes a protruding member which engages a notch on the other member when the stairs are in the full open, or locked position. When the stairs are opened, the device moves into a position which prevents the stairs from folding unintentionally. To unlock the assembly, the spring-like device is depressed thus releasing the protruding member from a corresponding notch, allowing the stairs to be folded to the closed position for stowing or transport.

### CROSS-REFERENCE TO RELATED APPLICATIONS

The present application claims priority to U.S. provisional patent application No. 61/066,205 filed Feb. 19, 2008. The entire disclosure of U.S. provisional patent application No. 61/066,205 is incorporated herein by reference.

### FIELD OF THE INVENTION

The present invention relates to a lockable folding stair.

### BACKGROUND OF THE INVENTION

Folding stairs for various applications, such as for use as a step ladders, are well known in the art. However, such stairs frequently fold unintentionally during use when not made to lock open, thus creating annoyance for the user and a potential safety hazard. Prior art folding stairs that have been made lockable are difficult to easily unlock for folding for stowage or transport. In addition, many lockable folding stairs have numerous parts and are therefore relatively expensive to manufacture. As a result, there is a need for a portable, lockable folding stair that is easy to lock and unlock and folds easily for storage. Additionally, there is a need for a portable, lockable folding stair that can be manufactured in two solid pieces.

### SUMMARY OF THE INVENTION

The present invention comprises an apparatus for overcoming the above-mentioned difficulties with existing folding stairs. The present invention provides an apparatus for allowing a set of stairs to fold open and closed, with a feature to lock the stairs in the open position to avoid unintentional closing during use, and a feature to allow the stairs to be easily unlocked for folding. One embodiment of the folding stair of the present invention comprises a first member having a plurality of steps distributed from a first end to a second end. The first end is adapted to be placed on a substantially flat surface. A second support member is used having a first end which is also adapted to be placed on the substantially flat surface. The second end of the second support member is rotatably coupled to the second end of the first member so that the two members can be moved relative to each other. The embodiment further comprises at least one locking mechanism having a springboard-like protrusion with a catch at an end of the protrusion. The protrusion is deployed on the second end of the second member and is designed to interact with a corresponding notch defined by a support structure located on the underside of the first member near its second end. This embodiment allows for the first and second members to rotate from a folded position for stowage to a locked extended position for use. When in the locked extended position, the catch of the protrusion abuts the support structure of the notch such that the first and second members are locked relative to each other. When the springboard protrusion is moved, the catch is released from the support structure, permitting the first and second members to rotate into the folded position.

The several embodiments of the present invention may be constructed such that the first stair member and the second back support member are made of molded plastic. In one embodiment, the catch can be molded together with the back support member. The back support member may also be molded so as to have two legs with an interconnecting structural support.

In one embodiment of the present invention, the first stair member is wider than the second support member so that the second member fits within the outer boundaries of the first member when in the folded position.

In another embodiment of the folding stair, the locking mechanism is located on the sides of the two operative members. At least one locking mechanism comprising a spring-like device having a biased protruding member is deployed on a side of one of the first and second members. The other member contains a hole that is shaped and positioned to receive the protruding member of the spring-like device when the folding stair is in an extended position for use. The first and second members rotate from a folded position for stowage to an extended position for use. For stowage, the protruding member of the spring-like device that protrudes through the hole must be moved out of the hole to unlock the folding stair, permitting the first and second members to rotate into the folded position.

In one of the embodiments, the component members are each a singled molded piece, thus combining to form a two-piece stair construction. This molded two-piece construction provides significant benefits in ease of manufacture and reduced costs of production. The springboard-like device of one embodiment includes a tooth one one of the two pieces which engages a notch on the other piece when in the full open, or locked position. When the stairs are opened, the device moves into a position which prevents the stairs from folding unintentionally. To unlock the assembly, the springboard device is depressed thus releasing the tooth from the notch, allowing the stairs to be folded to the closed position for stowing or transport.

### OBJECTS OF THE INVENTION

The following section of the written description describes some of the objects of the present invention, but the section is not exhaustive of all of invention's objects.

It is an object of the present invention to provide a folding stair which is easy to lock in the open position and then unlock and fold for storage.

It is a further object of the present invention to provide a two-piece lockable folding stair which is portable as well as easy and relatively inexpensive to produce.

### BRIEF DESCRIPTION OF THE DRAWINGS

The subject matter which is regarded as the invention is particularly pointed out and distinctly claimed in the claims at the conclusion of the specification. The foregoing, and other objects, features, and advantages of the present invention are shown and described in the following detailed description of the preferred embodiments which should be viewed in conjunction with the accompanying drawings in which:

FIG. 1 illustrates a frontal view of a stair construction of an exemplary embodiment of the present invention in the open and locked position;

FIG. 2 is a side view of an exemplary embodiment of the stair construction in the folded position;

FIG. 3 is a side view of the stair construction in FIG. 2 in the open and locked position;

FIG. 4 is a close-up view of a locking mechanism of an exemplary embodiment in the locked position;

FIG. 5 diagrammatically illustrates a person is a close up view of the locking mechanism shown in FIG. 4 being;

FIG. 6 is a partial cutaway view of one exemplary embodiment of the coupling between the two primary members of the folding stair;

FIG. 7 illustrates a cut-away view of the locking mechanism of FIG. 4 in a locked position;

FIG. 8 illustrates a cut-away view of the locking mechanism of FIG. 4 in an unlocked position;

FIG. 9 illustrates another embodiment of the present invention with the locking mechanism is incorporated into the side of the back support member; and

FIG. 10 illustrates a partial cutaway view of an exemplary embodiment of an alternative locking mechanism.

### DETAILED DESCRIPTION OF THE PREFERRED EMBODIMENT

The present invention relates generally to a foldable stair. It is important to note that the embodiments of the invention described below are only examples of some of the uses of the teachings described herein. In general, statements made in the specification do not limit any of the various claimed inventions. Moreover, some statements may apply to some inventive features but not to others. Unless otherwise indicated, singular elements may be in the plural and vice versa with no loss of generality. Similar reference numerals and letters represent similar components and system features throughout the drawings and the written description.

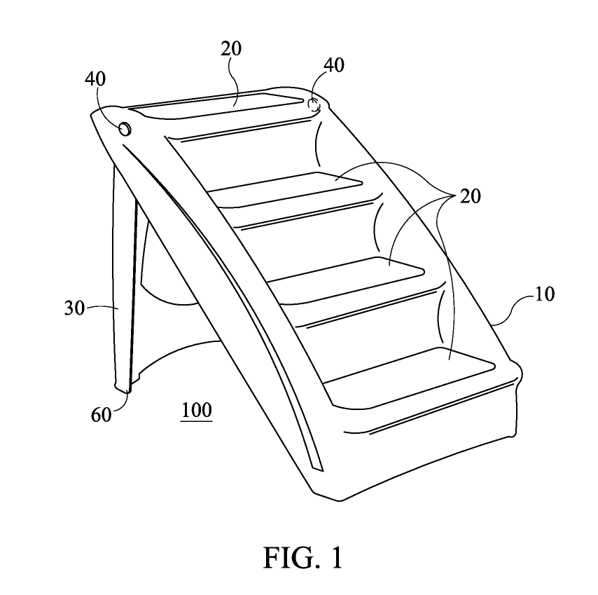

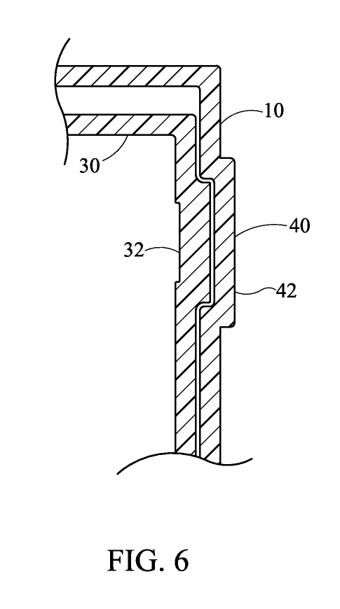

Reference is now made to FIG. 1, which a frontal view of a stair construction embodying the present invention in the open and locked position. As shown, the stair construction 100 includes a first, front piece or member 10, containing a plurality of steps 20, a second, back piece or supporting member 30, containing a plurality of legs 60, and hinges 40, about which front member 10, and back member 30, rotate and fold. The front member 10 and back member 30 are preferably each made of a molded single piece of any of the well-known plastics to minimize the cost of production. In the exemplary embodiment shown, the front member 10 is wider that the back member 30. However, the back member 30 can also be wider than the front member 10. In the preferred embodiment, one member is sized and shaped to fit within the other so as to minimize volume for stowage when the folding stair is in a closed, folded state. In the embodiment illustrated in FIG. 1, the sides of the two members 10, 30 are rotatably coupled about hinge 40. In FIG. 6, hinge 40 is constructed from the same plastic resin as the rest of members 10, 30. Members 10 and 30 each have corresponding circular shaped protrusions 32, 42 that are sized to fit within each other so as to allow one member to rotate relative to the other. The two members 10, 30 can be constructed of molded plastic such that one component can be pressure fitted into the other during construction as known to those of skill in the art. Other materials may also be used or a combination of materials as is known in the art. Similarly, other components and methods may be utilized to create the rotatable coupling between the front stair member 10 and the back support member 30 as is known in the art.

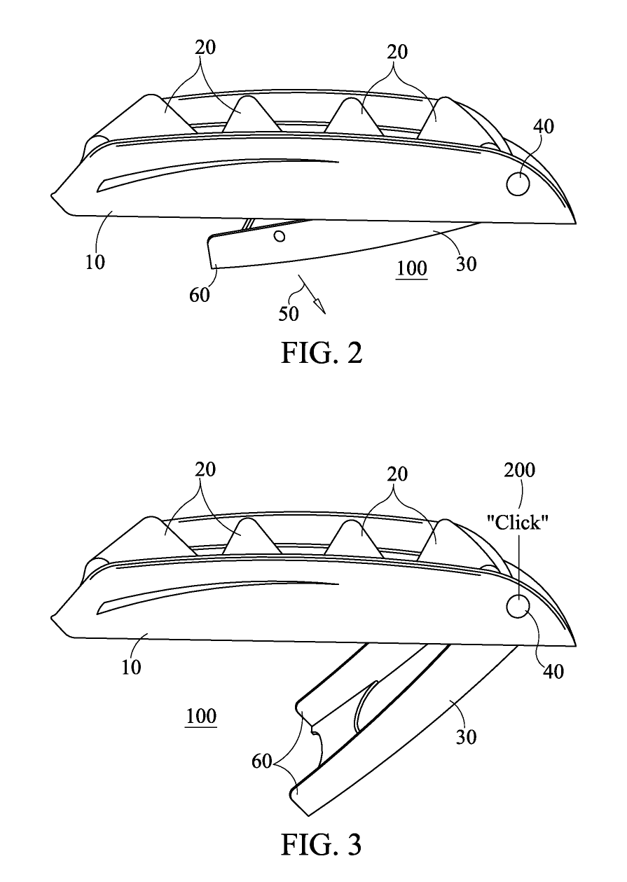

FIG. 2 illustrates a side view of the stair construction 100 in the folded or closed position, the front member 10 and the back member 30 have folded together by operation of the hinges 40. The stair construction can fold open from the position by the back member 30 swinging away from the front member 10 in the direction of motion indicated by arrow 50 by operation of the hinges 40.

In FIG. 3 illustrates a side view of one embodiment of the stair construction 100 in the open and locked position, the locking mechanism (not shown) is engaged, causing an audible “click” 200 upon the catch snapping into place. In this position the front member 10 and back member 30 are locked in position with respect to one another.

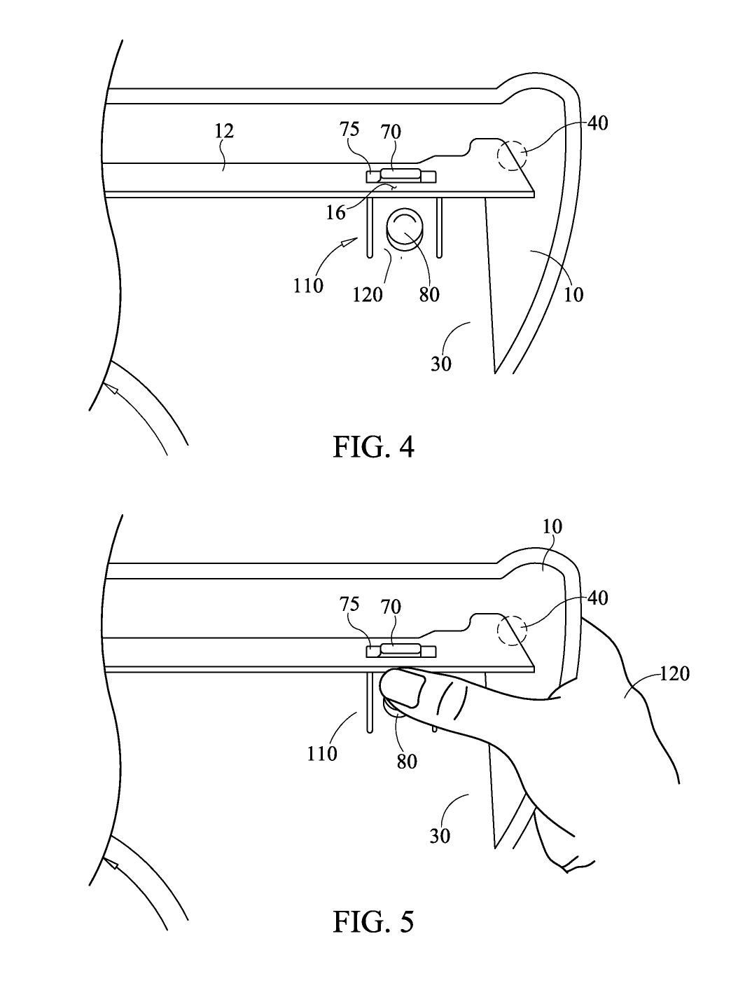

FIG. 4 diagrammatically illustrates a partial, close-up view of one embodiment of the locking mechanism 110 in the locked position. In the illustrated embodiment, the second, support member 30 includes a springboard-like protrusion 120. At the end of the protrusion 120 is a catch or tooth 70. In the illustrated embodiment, the protrusion 120 and catch 70 are part of the molded back member 30. In the illustrated embodiment, protrusion 120 includes a button 80. Button 80 is positioned to allow a person to depress the protrusion 120 as described later. In FIG. 4, front member 10 includes a supporting structure 12 running across the underside. Structure 12 defines a rectangular shaped notch 75 that aligns with the protrusion 120 of member 30. In other words, notch 75 is positioned to correspond with the location of the springboard-like protrusion 120 such that catch 70 may enter through notch 75. Support structure 12 can be constructed separately or may be a molded part of the front member 10. When the locking mechanism is engaged, the front member 10 and the second member 30 are locked in position with respect to one another. In the locked position, catch 70 comes in contact with the region 16 just below notch 75 preventing the support member 30 from rotating into the folding position.

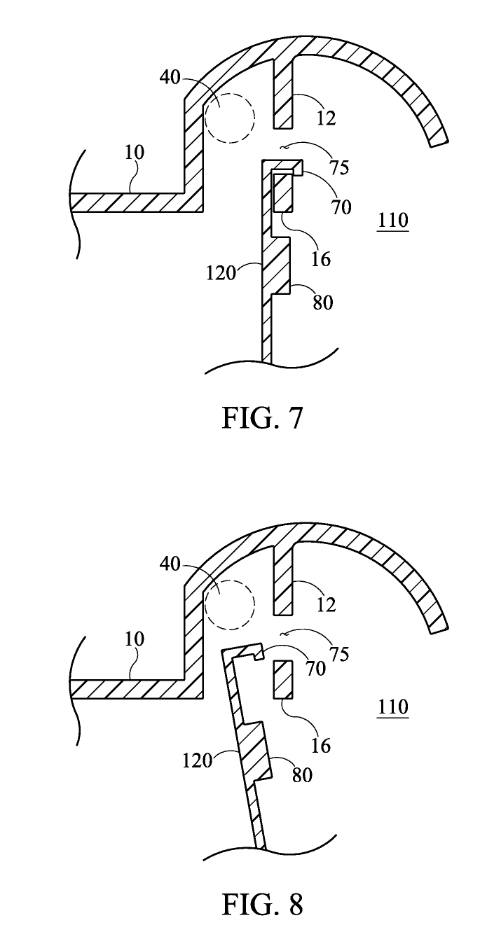

FIG. 7 illustrates a cut-away view of the locking mechanism of FIG. 4 in a locked position. The cutaway view shows how the locking mechanism prevents clockwise rotation of the back support member 30 relative to the front member 10 about hinge 40 (shown in dashed lines). FIG. 8 illustrates the locking mechanism in an unlocked position. Because the springboard-like protrusion 120 is depressed, catch 70 is unimpeded by the support structure 16 as the back support member 30 is rotated clockwise about hinge 40 into the folded position. In FIGS. 5 and 8, the tooth or catch 75 may be disengaged by depressing the springboard-like protrusion 120 at button 80, unlocking the stair construction 100 and allowing the front member 10 and back support member 30 to fold together by rotation about the hinges 40.

FIG. 5 illustrates a close-up view of the locking mechanism shown in FIG. 3. In FIG. 5, a user 120 is depressing the springboard-like protrusion 120 by placing a thumb on button 80.

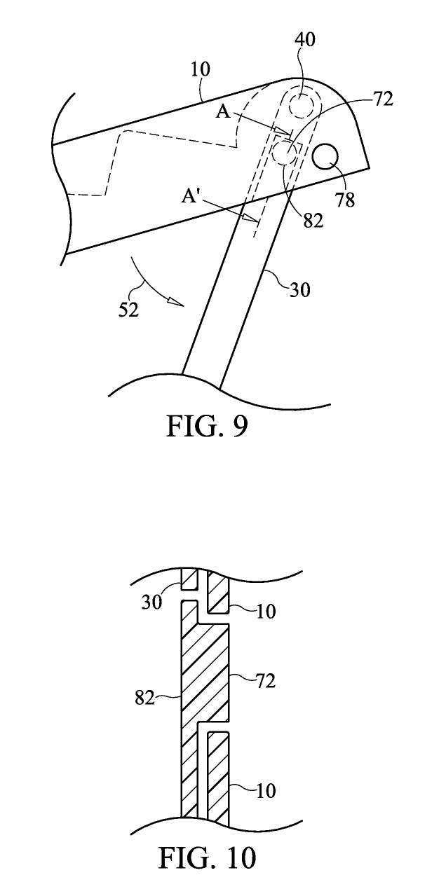

FIG. 9 illustrates another embodiment wherein the locking mechanism is a spring-like device 82 mounted on the side of the back member 30. The spring-like device 82 can be constructed similar to the springboard-like protrusion of the embodiment illustrated in FIG. 4 or can be a separately constructed component that it fit onto the back support member 30. The spring-like device 82 includes a protruding button 72. The side of front member 10 is constructed having a hole 78 that is shaped and positioned such that when back support member 30 is swung from a closed, folded position to an open, unfolded position, the button 72 aligns with the hole 72, causing the button to protrude through hole 72, causing the two members 10, 30 to lock in place. Hence, when the stairs are opened, the device moves into a position which prevents the stairs from folding unintentionally. In this embodiment, the button 72 of spring-like device 82 must be depressed and thus moved out of the way to allow the back piece to fold into the front piece for stowing or transport. FIG. 10 illustrates a partial cutaway view of an exemplary embodiment of this alternative locking mechanism from the perspective of AA′ in the locked position. Alternatively, the spring-like device 82 can be constructed separately and fastened to one of the two members such that a biased pin or protruding member locks the two members 10, 30 when the folding stair is in an open position. Such devices are known in the art of telescoping poles and can be used in connection with the present invention to lock the two components to prevent accidental folding of the stair during use.

While the present invention has been described with reference to the preferred embodiments, those skilled in the art will recognize that numerous variations and modifications may be made without departing from the scope of the present invention. Accordingly, it should be clearly understood that the embodiments of the invention described above are not intended as limitations on the scope of the invention, which is defined only by the following claims.

The claims appended hereto are meant to cover modifications and changes within scope and spirit of the present invention.

What is claimed is:

1. A folding stair comprising:
a first member having a plurality of steps distributed from a first end to a second end, said first end adapted to be placed on a substantially flat surface;
a second support member having a first end adapted to be placed on the substantially flat surface and a second end rotatably coupled to said second end of said first member;
at least one locking mechanism comprising a springboard-like protrusion having a catch at an end of said protrusion, said protrusion deployed on said second end of said second member, said protrusion and catch adapted to interact with a corresponding notch defined by a support structure located on the underside of said first member near said second end;
wherein said first and second members rotate from a folded position for stowage to a locked extended position for use; wherein when in said locked extended position said catch of said protrusion abuts said support structure of said notch such that said first and second members are locked; and whereupon movement of said springboard protrusion releases said catch from said support structure, permitting said first and second members to rotate into said folded position.

2. A folding stair as claimed in claim 1 wherein said first member further comprises a single component of molded plastic.

3. A folding stair as claimed in claim 2 wherein said catch and said second support member further comprise a single component of molded plastic.

4. A folding stair as claimed in claim 2 wherein said notch defined by said support member and said first member further comprise a single component of molded plastic.

5. A folding stair as claimed in claim 1 wherein said second member further comprises a single component of molded plastic having two legs and at least one interconnecting structural support.

6. A folding stair as claimed in claim 1 wherein said first member is wider than said second member and said second member fits within the outer boundaries of said first member when in said folded position.

7. A folding stair comprising:
a first member having a plurality of steps distributed from a first end to a second end, said first end adapted to be placed on a substantially flat surface;
a second support member having a first end adapted to be placed on the substantially flat surface and a second end rotatably coupled to said second end of said first member;
at least one locking mechanism comprising a spring-like device having a protruding member outwardly biased, said spring-like device deployed on a side of one of said first and second members, a hole defined by the other of said first and second member, said hole shaped and positioned to receive said protruding member of said spring-like device when the folding stair is in an extended position for use;
wherein said first and second members rotate from a folded position for stowage to said extended position for use; wherein when in said extended position said protruding member of said spring-like device protrudes through said hole such that said first and second members are locked; and whereupon movement of said protruding member out from within said hole releases said first and second members, permitting said first and second members to rotate into said folded position.

8. A folding stair as claimed in claim 7 wherein said first member further comprises a single component of molded plastic.

9. A folding stair as claimed in claim 8 wherein said spring-like device and said second support member further comprise a single component of molded plastic.

10. A folding stair as claimed in claim 8 wherein said hole is defined by said first member and said second support member further comprise a single component of molded plastic.

11. A folding stair as claimed in claim 7 wherein said second member further comprises a single component of molded plastic having two legs and at least one interconnecting support member.

12. A folding stair as claimed in claim 7 wherein said first member is wider than said second member and said second member fits within the outer boundaries of said first member when in said folded position.
